(19) United States
(12) Patent Application Publication
(10) Pub. No.: US 2022/0011431 A1
(43) Pub. Date: Jan. 13, 2022

(54) CAMERA SENSOR FOR LIDAR WITH DOPPLER-SENSING PIXELS

(71) Applicant: Xin Jin, Waterloo (CA)

(72) Inventor: Xin Jin, Waterloo (CA)

(21) Appl. No.: 16/926,400

(22) Filed: Jul. 10, 2020

(51) Int. Cl. G01S 17/89; G01S 7/4912

(52) U.S. Cl. CPC G01S 17/89; G01S 17/931; G01S 7/4916

(57) ABSTRACT

Doppler LIDARs, such as those used in ADAS (advanced driver assistance system) and autonomous vehicles, may need to sense objects at many directions. Some of the Doppler LIDAR devices use mechanically moving parts to scan over a range of directions and the various directions are not sensed simultaneously but sensed in turns over time. Mechanically moving parts generally have higher costs, less reliability and shorter Mean Time To Failure (MTTF). The camera sensor for LIDAR with Doppler-sensing pixels disclosed herein uses a Doppler sensing-chip that enables Doppler LIDAR devices to sense many directions simultaneously without having to use mechanical scan and mechanically moving parts, at least reduce the use thereof. Lower costs and higher reliability as well as higher direction sensing accuracy are objectives of this invention.

### BACKGROUND OF THE INVENTION

### Field of the Invention

This invention relates generally to utility of Doppler effects, in particular, to camera sensors for LIDAR having Doppler-sensing pixels.

### Description of the Related Art

LIDAR (light detection and ranging) devices are viewed as a major sensing means in an ADAS (advanced driver assistance system) of a vehicle, as well as in a driving control system of an autonomous vehicle. In order to “see” objects in various directions around the LIDAR receiver device, and to determine directions of the objects, mechanical means may be used to scan across directions by the LIDAR system, e.g. the continuously rotating platform used in prior art patents U.S. Pat. No. 8,836,922. It is known that mechanical scanning parts, especially those continuously moving mechanical parts, are subject to failures with shorter Mean time to failure (MTTF) and higher costs.

CW (continuous wave) and FMCW (frequency modulated continuous wave) Doppler LIDAR, as disclosed in prior U.S. Pat. No. 6,697,148 is a powerful sensing tool for applications such as ADAS and autonomous vehicles, however it performs speed and/or distance measurements at a single direction at a time. To sense objects in various directions, it may still have to use scanning means such as rotating mirror or other mechanically moving aiming means.

There is a need in the art to perform CW and/or FMCW Doppler detection and ranging in many or all directions of interest, without using mechanically moving parts.

### BRIEF SUMMARY OF THE INVENTION

In one aspect, the invention provides an embodiment of a Doppler camera sensor, comprising: an array of pixels; and an interface module, coupled with the pixels, for conveying sensing results outside the sensor; wherein each of the pixels comprising: a photo-detector for detecting a modulated light signal from objects being sensed, and producing a detected signal; and at least one mixer, coupled with the photo-detector and the interface module, for mixing at least one local replica signals with the detected signal or a signal derived from the detected signal, and producing at least one mixing product signals.

In another aspect, at least one embodiment of the invention provides a Doppler LIDAR receiver, comprising a Doppler sensor having an array of Doppler sensing pixels, for producing at least one Doppler sensing signals; an optical scope, optically coupled with the Doppler sensor, for producing an optical image of objects on the Doppler sensor; a digital signal processor module, coupled with the Doppler sensor, for processing the at least one Doppler sensing signals; and whereby, the array of Doppler sensing pixels each is operable to mix a detected light signal from or associated with an object under detection and exposed onto said pixel with a local replica signal, and produce at least one of the Doppler sensing signals; and whereby, the digital signal processor module is operable, based on at least one of the Doppler sensing signals produced by a pixel and an address of said pixel in the array, to detect at least one of: a relative moving speed of said object and direction of moving in terms approaching to or leaving from said LIDAR receiver; a distance between said object and said LIDAR receiver; and a direction of said object relative to said LIDAR receiver.

In yet another aspect, at least one embodiment of the invention provides an omnidirectional Doppler LIDAR receiver, comprising: a Doppler sensor having an array of Doppler sensing pixels, for producing at least one Doppler sensing signals; an optical scope, optically coupled with the Doppler sensor, for producing an optical image of objects on the Doppler sensor; a convex mirror, optically coupled with the optical scope, for redirecting lights from objects under detection in all directions of a hemisphere or partial hemisphere into the optical scope; a digital signal processor module, coupled with the Doppler sensor, for processing the at least one Doppler sensing signals; and whereby, the array of Doppler sensing pixels each is operable to mix a detected light signal from or associated with an object under detection and exposed onto said pixel with a local replica signal, and produce at least one of the Doppler sensing signals; and whereby, the digital signal processor module is operable, based on at least one of the Doppler sensing signals produced by a pixel and an address of said pixel in said array, to detect at least one of: a relative moving speed of said object and direction of moving in terms approaching to or leaving from said LIDAR receiver; a distance between said object and said LIDAR receiver; and a direction of said object relative to said LIDAR receiver.

Other aspects of the invention will become clear thereafter in the detailed description of the preferred embodiments and the claims.

### BRIEF DESCRIPTION OF THE DRAWINGS

For a better understanding of the invention and to show more clearly how it may be carried into effect, reference will now be made, by way of example only, to the accompanying drawings which illustrate distinctive features of at least one exemplary embodiment of the invention, in which:

FIG. 1, by way of example, illustrates a functional block diagram of a Doppler LIDAR receiver device using a camera sensor with Doppler sensing pixels;

FIG. 2 is a block diagram showing functions built into individual Doppler sensing pixels on the sensor chip shown in FIG. 1;

FIG. 3 illustrates an exemplary embodiment of an omnidirectional Doppler LIDAR camera for detecting objects in a space of hemisphere;

FIG. 4 is a concept illustration of an electronically reconstructed Doppler sensing panorama superimposed onto an a visible light panorama;

FIG. 5 illustrates another exemplary embodiment of an omnidirectional Doppler LIDAR camera for detecting objects in both upper and lower hemispheres;

FIG. 6 illustrates yet another exemplary embodiment of an omnidirectional Doppler LIDAR camera for detecting objects in both upper and lower hemispheres;

### DETAILED DESCRIPTION OF THE INVENTION

It will be appreciated that in the description herein, numerous specific details are set forth in order to provide a thorough understanding of the invention. However, it will be understood by those of ordinary skill in the art that the invention may be practiced without these specific details. In other instances, well-known methods, procedures and components have not been described in detail so as not to obscure the invention. Furthermore, this description is not to be considered as limiting the scope of the invention, but rather as merely providing a particular preferred working embodiment thereof.

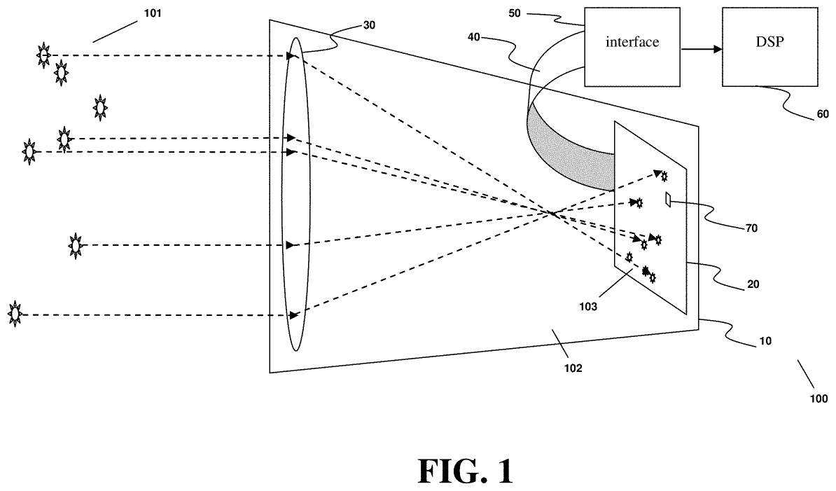

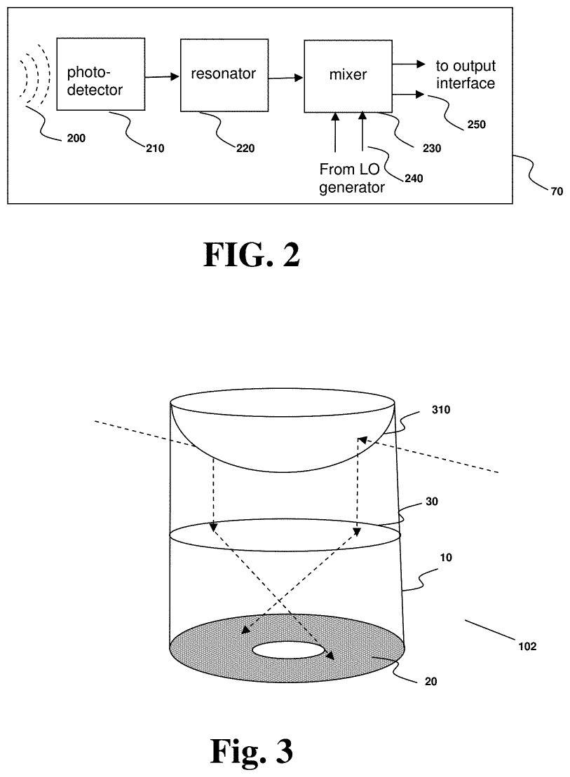

By way of example, FIG. 1 illustrates a functional diagram of a Doppler LIDAR receiver device using a camera sensor with direct Doppler sensing pixels. In the figure, objects 101 illuminated by modulated light source (such as disclosed in U.S. Pat. No. 6,697,148), or lights emitted by modulated light beacons 101 (such as disclosed in patent application U.S. Ser. No. 16/917,805), which are attached to objects being sensed, are sensed by at least one LIDAR receiver device 100 in an application field, comprising of a Doppler camera 102, a digital signal processor (DSP) module 60, an interface module 50 and interconnect wires 40. The Doppler camera 102 includes a housing 10 that may be designed in different shapes to hold the components of the Doppler camera, and suitable for being mounted on a platform using the camera, such as a car; a sensor chip 20 that contains an array of Doppler light sensing pixels, e.g., the pixel 70 as one of them, which will be explained in more detail with FIG. 2 hereinafter; an optical scope 30 that may be as simple as a lens as shown in the drawing, or a pinhole (including a pinhole-equivalent structure), or may be more complex to include a plurality of lenses, optical filter(s), aperture control means, focal adjustment means, zoom adjustment means, may further include mirrors and optical fiber or light guide, etc. (not shown in drawing); the modulated light signals from objects 101, either reflected by surface of the objects, or directly emitted from light beacon devices, will project their images 103 onto the pixels on a sensor chip 20, being Doppler-sensed by individual pixels e.g., the pixel 70 as one of them, as will be explained with FIG. 2; and on the chip, a portion of the semiconductor area implements an interface circuit (not shown in drawing) to collect the Doppler sensing output signals from the pixels on chip, and through the wires 40 to pass the signals to the mating interface module 50 for further processing at DSP 60. As can be seen in the figure, direction information of individual objects, as long as within the scope of view, is indicated by positions of pixels in the array on chip, electronically represented by its address, without the need of scanning using any moving mechanical means. The pixel address carries important information about direction of objects relative to the camera devices 102. In certain applications, it may be desirable to place the pixels on chip unevenly so as to optimize resolution of direction detection, and/or compensate deformation caused by optics. The physical shape of individual pixels may not have to be square or rectangular and may use other shapes to optimize or make tradeoff of performances and/or costs. The drawing of FIG. 1 is not drawn to scale.

FIG. 2 is a block diagram showing functions built into each of the Doppler sensing pixels 70 on the sensor chip 20 shown in FIG. 1. The modulated light signal 200 from one of the objects 101 (of FIG. 1) may be exposed to a pixel 70 in question through the optical scope 30. Preferably the pixel is on a focal plane of the optical scope 30 for the objects under detection. The strength of the light signal 200 will get detected into electrical signal in an area of semiconductor on the pixel that functions as photo-detector 210. Preferably the photo sensing area of the photo-detector 210 is as large as possible in the allowed pixel area to increase sensitivity of sensing. On top of a pixel, micro optical lens may also be built to direct light coming to the pixel onto the effective photo-detector area. The output signal from the photo-detector in an analog signal that reflects the instantaneous light strength exposed to the sensing area, including the amplitude waveform modulated onto the light source, which is the wanted signal, also may include strength variations superimposed onto the sensing area from other light sources, which is unwanted interferences. To increase signal to interference ratio in output of the photo-detector, optionally and preferably a resonator 220 is implemented within the semiconductor area of the pixel 70, which may be a LC circuit (inductor-capacitor tuning circuit) that resonates at the frequency band of the modulating signal (as used to modulate the light source, refer to prior art patent U.S. Pat. No. 6,697,148 and/or patent application U.S. Ser. No. 16/917,805), or may be a more sophisticated filter, to attenuate the frequency spectrum outside the modulating signal band of the modulated light signal. The photo-detector output signal, or filtered output signal of the photo-detector is then fed into a mixer 230, preferably an I-Q mixer, to be mixed with a local replica(s) 240 of the modulating signal or signals, which is a signal (or are signals) identical in frequency (or frequencies) to the one(s) used to modulate the light source. When an I-Q mixer is used, the local replica signal includes a phase shifted version of 90 degrees for each of the tone frequencies in use, as known to the skilled in the art. Also as an art known to the skilled, the mixer can be built in various ways, one simple embodiment is a diode ring, each of the I-Q arms is built by four diodes. More sophisticated multipliers such as four quadrant multiplier may also be used as long as suitable for the frequency in use and takes acceptable area of the pixel of semiconductor. It is well-known to the skilled in the art how to optimize the mixer circuit and local replica signal waveform and level, e.g., using a rectangular wave counterpart of local replica, combining the local replica components vs. separately mixing each of the components of local replica signal. The output of the mixer is a mixing product signal 250, containing Doppler shifts in a CW modulated use case, also containing frequency shifts if FMCW signal is used in modulating the light source, which can be used to derive range (distance) of the object sensed by the pixel in question. As an art known to the skilled, the way of deriving speed and range (distance) is not explained herein. The local replica signal(s) is shown in the figure as coming from a LO (local oscillator) generator, in embodiments where the modulated light source is co-located in the same device (e.g., as in U.S. Pat. No. 6,697,148) the LO generator may be simply the one used in the light transmitter; whereas in embodiments where the modulated light source is away from the LIDAR receiver device, e.g., the beacon embodiment or the illuminator embodiment as disclosed in patent application U.S. Ser. No. 16/917,805, the LO generator may need to be built according to what teaches in application U.S. Ser. No. 16/917,805. In either case, the generator produces the local replica signal(s) to feed all pixels on the sensor chip 20. Preferably the mixing product signals from the mixer 230 are amplified before sending out of the pixels, and the amplifier (not shown in drawing) may be implemented as a part of the mixer 230. Since not the entire area of the pixel silicon are used for implementing the photo-detector, for improved sensitivity and signal to noise ratio, in a preferred embodiment, an optical micro lens (not shown in drawing) may be placed on top of each pixel to direct more lights exposed onto the pixel to the silicon or semiconductor area of the photo-detector.

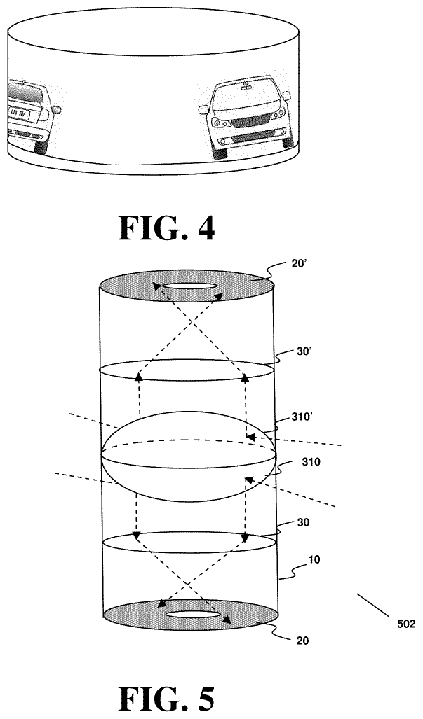

The light sensing area containing Doppler sensing pixel array in sensor chip 20 does not have to use rectangular shape, in some application scenarios, shapes other than rectangular may be preferred. FIG. 3 illustrates an exemplary embodiment of an omnidirectional Doppler camera 102, in which the camera structure is supported by a housing 10 which is transparent for the upper portion to allow light signals to come in from all 360 degrees around the horizontal plane and nearly entire lower hemisphere; a lens or a set of lenses 30 makes the images focus on the sensing pixels on Doppler sensor chip 20; a specially designed convex mirror 310, which may be built according to what patent U.S. Pat. No. 6,744,569 teaches, reflects light signals of objects from all directions around horizontal plane and lower hemisphere onto the sensor pixels on chip 20. As will be appreciated, the effective sensing area of the pixel array may be preferred to shape as a ring plate, and through DSP means, the images sensed by the pixel array on the ring plate shaped area may be electronically reconstructed into a Doppler sensing Panorama, superimposed onto an a visible light Panorama as needed, for example, like the one shown in FIG. 4 for human viewing. For machine sensing and autonomous driving purpose, reconstructing into a Panorama might not be necessary, as driving decisions may be as conveniently made based on sensed information as “flattened” on a ring shaped plate. The drawing of FIG. 3 is for purpose of showing concepts, and is not drawn to scale. The center part and corners of the silicon not used for building pixels may be used to build supplementary circuits for the chip, e.g., the interface, LO buffering and distribution, power regulation and distribution, which will not be elaborated herein.

For pixel array of rectangular shape on the sensor chip, individual pixels may be evenly placed according to grids of Cartesian coordinates, parallel to the edges, and address of the pixels are numbered accordingly, to represent direction of sensed objects. For pixel arrays of circular shape or ring shape, the individual pixels may be places along polar coordinates, e.g., spaced by equal polar angle and radial length to reflect equal angular step size of incoming lights from objects that form images at positions of pixels. Since in some applications, not all directions are of equal importance, multiple zones on the pixel array may be implemented with different pixel densities. Uneven spaced pixels may be implemented to correct optical deformity as well.

FIG. 5 illustrates another exemplary embodiment of an omnidirectional Doppler camera 502, to be able to sense objects in both lower and upper hemispheres, which is essentially a duplicated camera structure as in FIG. 3 and is not elaborated again herein. Again the drawing of FIG. 5 is for purpose of showing concepts, and is not drawn to scale.

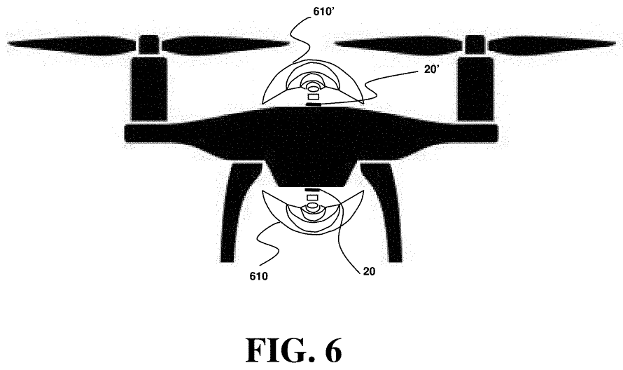

In an alternative embodiment, the convex mirror(s) and the scope(s) in embodiments of FIGS. 3 and 5 may be replaced by a fish-eye optical scope and achieve nearly 180 degree view of a hemisphere, and two of such structure together will be able to perform Doppler sensing substantially in both upper and lower hemispheres. FIG. 6 shows an example of such omnidirectional Doppler camera, in which the two Doppler sensors 20 and 20′ are placed on upper and lower side of a drone, and fish-eye scopes 610 and 610′ are installed in front of the sensor chips to project omnidirectional image onto the Doppler sensors 20 and 20′, one to sense the lower hemisphere and the other to sense the upper hemisphere (The drawing is not drawn to scale).

The amount of Doppler sensing data to be transferred out of the sensor chip 20 depends on 1) total number of pixels; 2) maximum bandwidth in the mixing product signals, which is proportional to the maximum Doppler shift of concern in the application, and in embodiments using FMCW modulating signal, it also depends on FM sweeping rate and maximum range in design. If the data interface is able to convey all digitized data from all pixels, then the chip may simply passing the mixing product signals through an anti-aliasing filter (not shown in drawings of FIGS. 1 and 2) and then use analog to digital converter (not shown in drawings too) to digitize the filtered analog signal, time multiplexing the data by the interface circuits on chip (not shown in drawings), and send them out. If the amount of data is too large to be all passed, it is preferable to locally pre-process the result and select to pass only the output signals from “important” pixels.

What pixels are “important”? How does the sensor chip 20 determine it? The answer is application dependent. Take the example of autonomous vehicle application in a “controlled” traffic region, in which all vehicles are equipped with beacon transmitters (e.g., the ones described in patent application U.S. Ser. No. 16/917,805), and all land structure in the region are also marked by such beacons, then the important pixels may be those with beacon signals exposed onto them that are much stronger than reflected background signals. The ones with closer distances and positive Doppler shifts (i.e., approaching objects) are most important ones since they are the objects may have higher potential risk of collisions with the vehicle in question. In application scenarios to detect reflected signals, the signal strength may not be a reliable measure as the signal strength depends not only on distance and size of objects, but also depends on surface properties of objects. In this case, a high positive Doppler as well as close distance may be good criteria for selecting important pixels to output data.

On-chip hot spot detection is a pre-selection of pixels and their neighboring ones that need to watch with higher attention, so as to output these data to off-chip DSP for further processing. For signal strength based selection, may use sum-and-dump (integrate and discharge) of absolute values/magnitude of mixing product signals at a given time interval, and pass the results to a threshold; for Doppler shift based selection, may use threshold comparator (preferably with appropriate amount of hysteresis) to detect and count number of “sign” changes in the mixing product signals from mixers that mix with CW local replicas during a given time interval to determine, or alternatively based on time needed for a given number of “sign” changes thereof to determine, and in either case, may choose to only count the “sign” changes in the direction of phase rotations for positive Doppler shifts (approaching objects). As known in the art, distance may also be determined based on frequency information from both the CW mixer outputs and FMCW mixer outputs. In the selection of important pixels, quick and potentially less accurate processing may be used, and relying on more accurate further processing on DSP 60 for final processing.

In an alternative embodiment, the DSP 60 may be implemented on the sensor chip 20 in entirety or partially, so that processing of signals created by all pixels are performed within the chip 20.

In some application scenarios, it is desirable to illuminate surroundings simultaneously using said modulated light source, so that all directions of sensing interest will be illuminated. One embodiment to achieve this is to use the apparatus shown in FIG. 3 in a reversed light propagation direction, i.e., the modulated light source is placed at position of 20, emits the modulated light, and the light comes out through the optics 30 and is reflected by convex mirror 310 towards surrounding objects. Light energy may also be more densely focused towards directions that need longer illumination range, e.g., more concentrated towards front than back and sides in vehicular applications.

Certain terms are used to refer to particular components. As one skilled in the art will appreciate, people may refer to a component by different names. It is not intended to distinguish between components that differ in name but not in function.

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances.

Also, the term “couple” in any form is intended to mean either a direct or indirect connection through other devices and connections.

It should be understood that various modifications can be made to the embodiments described and illustrated herein, without departing from the invention, the scope of which is defined in the appended claims.

I claim:

1. A camera sensor, comprising:
an array of pixels; and
an interface module, coupled with the pixels, for conveying sensing results outside the sensor;
wherein each of the pixels comprising:
a photo-detector for detecting a modulated light signal from or associated with objects being sensed, and producing a detected signal; and
at least one mixer, coupled with the photo-detector and the interface module, for mixing at least one local replica signals with the detected signal or a signal derived from the detected signal, and producing at least one mixing product signals.

2. The pixels of claim Error! Reference source not found, each further includes a first filter, coupled with the photo-detector and the mixer, for attenuating interference and noise outside frequency band of a modulating signal used to modulate the modulated light signal.

3. The pixels of claim Error! Reference source not found, each further includes a second filter or filters, coupled with the mixer, for attenuating frequency components outside band of interest in the mixing product signal.

4. The at least one mixer of claim Error! Reference source not found. includes:
a quadrature mixer;
a plurality of mixers or quadrature mixers, each separately mixing the detected signal or a signal derived from the detected signal with one of:
at least one CW components of the local replica signals;
at least one FMCW components of the local replica signals;
one CW component of the least one CW components of the local replica signals;
one FMCW component of the least one FMCW components of the local replica signals;
a square wave counterpart of one CW component of the least one CW components of the local replica signals; and
a square wave counterpart of one FMCW component of the least one FMCW components of the local replica signals.

5. The pixels of claim Error! Reference source not found, each further includes a micro optical lens on top of said each pixel, for directing light exposed onto the pixel area more onto the photo-detector area of said each pixel.

6. The camera sensor of claim Error! Reference source not found, further includes at least one pre-processing functional module, coupled with the mixers of the pixels, for pre-processing the mixing product signals, and selecting, among all, some of the pixels with their addresses and mixing product signals to be exported for further processing.

7. The camera sensor of claim 6, wherein the pre-processing functional module functions as at least one of:
an estimator that estimates a quantity associated with a strength of detected said modulated light signals;
an estimator that estimates a quantity associated with a Doppler shift of detected said modulated light signals in its CW modulated envelop;
an estimator that estimates a quantity associated with a frequency shift of detected said modulated light signals in its FMCW modulated envelop; and
an estimator that estimates a quantity associated with a distance of an object associated with detected said modulated light signals.

8. The camera sensor of claim Error! Reference source not found, further includes at least one of:
at least one first amplifiers, coupled with the photo-detectors and the mixers, for amplifying the detected signals;
at least one second amplifiers, coupled with the mixers, for amplifying the mixing product signals;
at least one filters, coupled with the mixers, for attenuating frequency components outside band of interest in the mixing product signals;
at least one analog to digital converters, coupled with the mixers, for digitizing the mixing product signals; and
at least one digital signal processor module, coupled with the pixels for processing the mixing product signals.

9. The camera sensor of claim Error! Reference source not found. is built on a semiconductor chip.

10. The camera sensor of claim 9 wherein the array of pixels are placed on the semiconductor chip in an area of at least one of:
a rectangular shape;
a round shape;
a ring shape;
an oval shape;
an oval ring shape; and
a curved belt shape.

11. The camera sensor of claim 9 wherein the array of pixels are placed on the semiconductor chip and spaced according to at least one of:
Cartesian coordinates; and
polar coordinates.

12. The camera sensor of claim 9 wherein the array of pixels are placed on the semiconductor chip in a plurality of zones, and wherein, in each of the zones the pixels are placed evenly according to one of a Cartesian or a polar coordinates, and densities of placement are based on the zone the pixels belong to.

13. A Doppler LIDAR receiver, comprising:
a Doppler sensor having an array of Doppler sensing pixels, for producing at least one Doppler sensing signals;
an optical scope, optically coupled with the Doppler sensor, for producing an optical image of objects on the Doppler sensor;
a digital signal processor module, coupled with the Doppler sensor, for processing the at least one Doppler sensing signals; and
whereby, the array of Doppler sensing pixels each is operable to mix a detected light signal from or associated with an object under detection and exposed onto said pixel with a local replica signal, and produce at least one of the Doppler sensing signals;
and whereby, the digital signal processor module is operable, based on at least one of the Doppler sensing signals produced by a pixel and an address of said pixel in the array, to detect at least one of:
a relative moving speed of said object and direction of moving in terms approaching to or leaving from said LIDAR receiver;
a distance between said object and said LIDAR receiver; and
a direction of said object relative to said LIDAR receiver.

14. An omnidirectional Doppler LIDAR receiver, comprising:
a Doppler sensor having an array of Doppler sensing pixels, for producing at least one Doppler sensing signals;
an optical scope, optically coupled with the Doppler sensor, for producing an optical image of objects on the Doppler sensor;
a convex mirror, optically coupled with the optical scope, for redirecting lights from objects under detection in all directions of a hemisphere or partial hemisphere into the optical scope;
a digital signal processor module, coupled with the Doppler sensor, for processing the at least one Doppler sensing signals; and
whereby, the array of Doppler sensing pixels each is operable to mix a detected light signal from or associated with an object under detection and exposed onto said pixel with a local replica signal, and produce at least one of the Doppler sensing signals;
and whereby, the digital signal processor module is operable, based on at least one of the Doppler sensing signals produced by a pixel and an address of said pixel in said array, to detect at least one of:
a relative moving speed of said object and direction of moving in terms approaching to or leaving from said LIDAR receiver;
a distance between said object and said LIDAR receiver; and
a direction of said object relative to said LIDAR receiver.

15. The omnidirectional Doppler LIDAR receiver of claim 14, wherein the convex mirror is substantially a hyperbolic mirror.

16. The omnidirectional Doppler LIDAR receiver of claim Error! Reference source not found, wherein the array of Doppler sensing pixels are placed in an area shaped as one of:
a round shape; and
a ring shape.

17. The omnidirectional Doppler LIDAR receiver of claim 14, further includes another duplicated set of the omnidirectional Doppler LIDAR receiver on the opposite side, so that the two hemispherical omnidirectional Doppler LIDAR receivers together forms a spherical omnidirectional Doppler LIDAR receiver.

18. The omnidirectional Doppler LIDAR receiver of claim Error! Reference source not found, wherein the convex mirror and the optical scope are replaced by a fish-eye lens scope.

19. The omnidirectional Doppler LIDAR receiver of claim 18, further includes another duplicated set of the omnidirectional Doppler LIDAR receiver on the opposite side, so that the two hemispherical omnidirectional Doppler LIDAR receivers together forms a spherical Doppler LIDAR receiver.
